(19) United States
(12) Patent Application Publication
(10) Pub. No.: US 2007/0234811 A1
(43) Pub. Date: Oct. 11, 2007

(54) Vibrating sensor

(75) Inventors: Josef Fehrenbach, Haslach (DE); Martin Mellert, Steinach (DE)

Correspondence Address: THE NATH LAW GROUP, 112 South West Street, Alexandria, VA, 22314, US

(73) Assignee: VEGA Grieshaber KG, Wolfach (DE)

(21) Appl. No.: 11/730,200

(22) Filed: Mar. 30, 2007

Related U.S. Application Data
(60) Provisional application No. 60/789,222, filed on Apr. 5, 2006.

(30) Foreign Application Priority Data
Apr. 5, 2006 (DE) 10 2006 016 355.9

(51) Int. Cl. G01H 11/00

(52) U.S. Cl. 73/649

(57) ABSTRACT

The invention relates to a vibrating sensor with a diaphragm (2) that can be set into vibration; and with a transformer device (4) for setting the diaphragm (2) into vibration and/or for tapping a vibration S in the diaphragm; and with a vibrating body (3) and/or a diaphragm (2) in the form of a vibrating body, for transmitting the vibrations (S) of the diaphragm (2) to an ambient space (7) and/or for transmitting the vibrations (S) from an ambient space (7) to the diaphragm (2). The transformer device (4) exhibits a coil (8) and a bolt (6), such that the bolt (6) is connected to the diaphragm (2) in order to transmit the vibrations (S) to or from the diaphragm (2), and the coil (8) and the bolt (6) are positioned to so interact that a vibration (S) in the bolt (6) induces a flow of current in the coil (8) and/or a flow of current in the coil induces a magnetic field (B) and brings about a vibration in the bolt (6).

The invention relates to a vibrating sensor with the features of the preamble of claim 1.

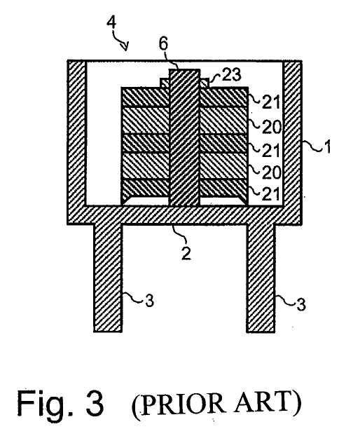

A vibrating sensor illustrating the prior art and diagrammed in FIG. 3 consists of a housing 1, with a diaphragm 2 secured to the face of the housing 1. The diaphragm 2 runs perpendicular to the cylindrical housing walls of the housing 1. Projecting from the diaphragm 2 are vibrating forks 3, which serve to transmit vibrations from the diaphragm 2 into the surrounding area, or from the surrounding area to the diaphragm 2. Integrated into the housing is a transformer device 4, which serves to transform mechanical vibrations into electrical signals or electrical signals into mechanical vibrations. The transformer device 4 consists of a central bolt 6, which is firmly attached to the diaphragm 2, so that vibrations are transmitted from the bolt 6 to the diaphragm 2 and vice versa. The bolt 6 runs through a stack of piezoelectric elements 20 and the spring washers 21 encompassing them, such that a portion of the spring washers 21 are designed as electrodes for the piezoelectric elements 20. By means of a tension screw 23, the spring washers 21 (of which the central washer must consist of insulating material, e.g., a ceramic material) and the piezoelectric elements 20 are braced against the diaphragm 2, the tension screw 23 engaging in an outer thread of the bolt 6.

A disadvantage of this kind of design rests in the fact that the entire area of the lowermost spring washer 21, or a circumferential section of its outer circumference, is braced against the diaphragm 2. This arrangement—in which the rigid stack of the transformer device 4 rests against the diaphragm 2, both in the center of the stack and in the area of its outer circumference—brings about a disadvantageous stiffening of the diaphragm 2.

Drives of this kind always involve a direct frictional connection with the vibrating diaphragm 2. If this frictional connection changes, the resonant frequency is influenced, so that it is necessary to correct the excitation signals for the piezoelectric elements and/or the reception signals in the piezoelectric elements 20. When the transformer device 4 is designed to provide drives for the diaphragm 2, along with the piezoelectric elements 20 and the spring washers 21 or electrodes, the resonant frequency of the entire configuration is also established, since the package consisting of piezoelectric elements 20 and electrodes, or spring washers 21 and insulating disks 21, must either be glued to the diaphragm 2 or braced against the diaphragm 2 by means of a stack and a bolt 6.

In addition to the disadvantage imposed by a direct frictional connection, which makes the vibrating diaphragm rigid and thereby changes the resonant frequency, further disadvantages arise when the transformer device 4 employs piezoelectric elements 20. When a vibrating sensor of this kind has to be employed at temperatures up to 450° C., it is impossible to use piezoelectric elements, or is possible only at great expense. With such configurations, furthermore, it must be ensured that the piezoelectric elements are not mechanically damaged, particularly at high temperatures. A further disadvantage lies in the thermal behavior of the piezoelectric elements, electrodes, insulating disks, and spring washers, where a continuous bias can only be ensured with difficulty, or not at all, for usage over a large temperature range.

The goal of the invention is to propose a vibrating sensor with a transformer device of alternative design. In particular, it must be possible to excite a vibrating fork and a diaphragm without producing a direct frictional connection between the diaphragm 2 and the transformer device, in order to thereby reduce or eliminate effects exerted by the transformer device on the vibrating frequency.

This goal is achieved by a vibrating sensor with the features of patent claim 1. Advantageous elaborations are the subject matter of dependent claims.

Preferred accordingly is a vibrating sensor with a diaphragm that can be set into vibration, and with a transformer device for setting the diaphragm into vibration and/or for tapping a vibration in the diaphragm; and with a vibrating body and/or a diaphragm in the form of a vibrating body, for transmitting vibrations in the diaphragm to an ambient space and/or for transmitting vibrations from an ambient space to the diaphragm. The transformer device exhibits a coil and a bolt, such that the bolt is connected to the diaphragm in order to transmit the vibrations to or from the diaphragm, and the coil and the bolt are positioned to so interact that a vibration in the bolt induces a flow of current in the coil and/or a flow of current in the coil creates a magnetic field and brings about a vibration in the bolt.

A configuration of this kind particularly ensures that a vibrating fork can be excited without direct frictional connection between the transformer device and the diaphragm, and thus the vibrating fork. This advantageously ensures that the transformer device providing a drive has little or no influence on the vibrating frequency or resonant frequency. This also advantageously ensures a clear improvement in long-term stability with respect to the vibrating frequency of the vibrating sensor. Another advantage rests in the fact that temperature-dependent changes manifested by expansion of the contraction [sic] in the components of the transformer device no longer have an influence on the vibrating characteristics.

Particularly preferred is a vibrating sensor in which the bolt is made of a magnetic material, or a material that can be rendered magnetic, such that it ideally interacts with the coil. The bolt will preferably be secured directly to the diaphragm or will form a single piece with the diaphragm. Ideally the bolt will be positioned in the center of the diaphragm. It is advantageous if the bolt is coupled to a plunger-type capacitor in order to tap a vibration in the bolt as a measuring signal.

Particularly preferred is a vibrating sensor in which the coil is secured to one wall of a housing. The coil can be advantageously seated on a coil base, such that the base secures the coil relative to one wall of the housing.

Particularly preferred is a vibrating sensor in which the diaphragm is positioned on, and specifically secured to, one wall of a housing. However the diaphragm may also be designed as a component part of the housing wall, to form a single piece with the latter.

Advantageous is a vibrating sensor with a coil conductor which is electrically insulated with a temperature-resistant jacket. Here it is preferred that the coil conductor consists of ceramic material.

Advantageous is a vibrating sensor whose components, particularly the coil conductor, are temperature-resistant up to at least 350° C. and particularly up to 450° C. Resistances beyond this temperature limit can also be advantageously accommodated for future applications.

An exemplary embodiment will next be described in greater detail on the basis of the drawing, which shows:

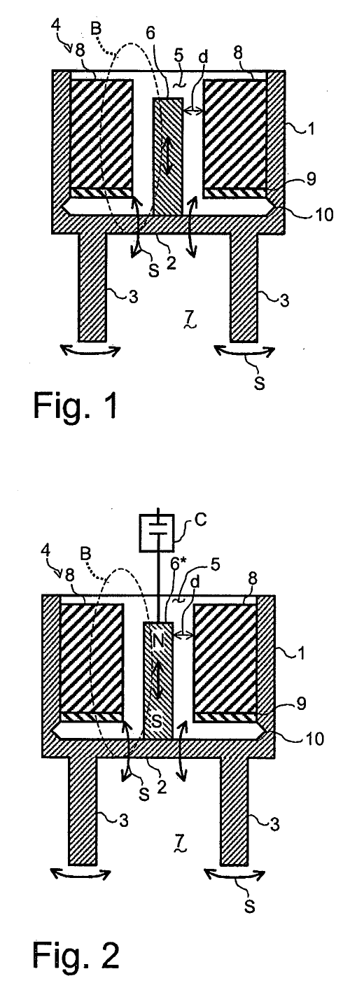

FIG. 1 an initial embodiment of a preferred vibrating sensor, in a sectional view

FIG. 2 a second embodiment of the vibrating sensor, in a sectional view

FIG. 3 an exemplary vibrating sensor of the prior art, in a sectional view

FIG. 1 gives a sectional view through a preferred embodiment of a vibrating sensor. In order to elucidate the basic principle only the fundamental components are shown. Other components, such as the connecting cable or housing lid, are omitted for the sake of clarity. The depicted components—for example, the housing wall—can be modified in their concrete form.

The figure shows an exemplary housing 1, with a housing wall, preferably of cylindrical shape. Secured to the face of the housing 1 is a diaphragm 2, which, with respect to its dimensions, method of attachment, and/or material, is designed to permit vibration. Ideally, but not as a required feature, vibrating forks 3 will project from the diaphragm in order to transmit a vibration S in the diaphragm to the space 7 surrounding the vibrating forks 3. In addition, or as an alternative, it is possible for vibrations to be transmitted from the space 7 to the diaphragm 2 via the vibrating forks, or directly from the space 7 to the diaphragm 2, so that said diaphragm 2 is set into vibration S.

Positioned in the interior 5 of the housing 1 is a transformer device 4, which serves as a drive device and converts applied electrical signals into a vibration; this vibration, in turn, is transmitted to the diaphragm 2. In addition, or as an alternative, vibrations can also be transmitted from the diaphragm 2 to the transformer device 4 and be converted into currents.

According to a particularly preferred embodiment, the transformer device 4 consists of a coil 8, which surrounds a bolt 6; this bolt 6 can be magnetized. The bolt 6 is positioned between the inner walls of the coil 8, in a fashion that permits movement in the direction of a magnetic field B that is induced by the coil 8. A gap d between the outer circumference of the bolt 6 and the inner circumference of the coil 8 will preferably be kept small, both to allow the bolt to move freely in its longitudinal direction and as to afford a structural design that is as compact as possible.

On its one face the bolt 6 is firmly connected to the diaphragm 2, e.g., through adhesion or welding, in order to allow that movement, relative to the housing, that is imposed on the bolt by the magnetic field B of the coil 8 to be transmitted to the diaphragm 2. In the reverse direction, a vibration S in the diaphragm 2 will lead to a corresponding movement of the bolt 6 within the coil, with the result that a flow of current corresponding to the vibration is induced in the coil 8.

Various modifications can be made in the preferred embodiments. For example, the transitional area from the housing 1 to the diaphragm 2 can be provided with an attenuation 10, particularly in the case of a single-piece design, in order to avoid too rigid a coupling between the diaphragm 2 and the wall of the housing 1. It is also possible to position the diaphragm 2 on an inner wall of the housing or on the housing itself through the use of an additional coupling element. Also possible, in principle, is a single-piece design for the diaphragm 2 and the bolt 6, to thereby to avoid a two-piece manufacturing process and the further need to attach the bolt 6 to the diaphragm 2.

In principle, the vibrating forks 3 can also be omitted if the diaphragm 2 is so designed that vibrations S in the diaphragm 2 can be directly transmitted from the diaphragm 2 into the space 7, or can be received by it from the space 7.

In addition to positioning the coil 8, by means of its outer circumference, on an inner wall of the housing 1, the coil 8 may also be positioned on a coil base 9, which is secured to the wall of the housing 1 or which forms a single piece with that wall. This will permit the selection of a special coil, in accordance with the specific application, or the exchange of coils 8, for example when a given coil 8 is no longer functioning securely due to age or the effects of heat.

For use at higher temperatures the use of a coil 8 with a temperature-resistance jacket for the coil conductor is preferred. This kind of temperature-resistant jacket can consist of, e.g., a ceramic material, which electrically insulates the coil conductor and permits usage at temperatures up to 350° C., particularly up to 450° C., or at even higher temperatures.

FIG. 2 shows an embodiment that has been modified vis-à-vis that of FIG. 1. In the following, only differing components are described.

In the first embodiment a bolt 6 that can be magnetized is attached to the diaphragm as a pull bolt, so that the bolt 6 is drawn inwardly through the coil, without stiffening the diaphragm 2 in the process. In the second, modified embodiment a magnetized bolt 6* is attached to the diaphragm 2. This kind of magnetic or magnetized bolt 6* very advantageously permits the vibrating diaphragm 2 to be driven in both of the bolt's vibrating directions.

In the modified embodiment the bolt 6* is additionally coupled to a plunger-type capacitor C. This makes it possible to tap a vibrating movement of the diaphragm 2 or. as the case may be, the bolt 6* directly at the bolt 6* and not by the indirect induction of an electric current in the coil 8. In addition to a configuration involving this kind of plunger-type capacitor C on the face of the bolt 6*, comparable capacitor arrangements may be provided, e.g., at the side of the bolt 6*, for example in an area on the front of the coil 8, between said coil 8 and the diaphragm 2.

Vibrating sensors of this kind can be employed to advantage, particularly when there are elevated ambient temperatures. A corrosion measurement can be advantageously executed with the vibrating fork 3, such that the measuring signal is derived from the resonant frequency of the vibrating fork 3 and/or the diaphragm 2. This is especially advantageous and is made possible by the fact that the resonant frequency, or vibrating frequency, is not influenced by undesired secondary effects caused by a rigid drive device or one that is braced firmly against the diaphragm.

1. A vibrating sensor with
a diaphragm (2) that can be set into vibration,
a transformer device (4) for setting the diaphragm (2) into vibration (S) and/or for tapping a vibration S in the diaphragm, and
a vibrating body (3) and/or a diaphragm (2) in the form of a vibrating body, for transmitting the vibrations (S) of the diaphragm (2) to an ambient space (7) and/or for transmitting the vibrations (S) from an ambient space (7) to the diaphragm (2),
wherein
the transformer device (4) exhibits a coil (8) and a bolt (6; 6*),
such that the bolt (6; 6*) is connected to the diaphragm (2) in order to transmit the vibrations (S) to or from the diaphragm (2), and
the coil (8) and the bolt (6; 6*) are positioned to so interact that a vibration (S) in the bolt (6; 6*) induces a flow of current in the coil (8) and/or a flow of current in the coil induces a magnetic field (B) and brings about a vibration in the bolt (6; 6*).

2. A vibrating sensor according to claim 1,
wherein
the bolt (6) consists of a material that can be magnetized.

3. A vibrating sensor according to claim 1,
wherein
the bolt (6*) consists of a magnetic material.

4. A vibrating sensor according to claim 1,
wherein
the bolt (6; 6*) is secured directly to the diaphragm (2) or is designed to form a single piece with the diaphragm (2).

5. A vibrating sensor according to claim 1,
wherein
the bolt (6; 6*) is positioned on the diaphragm (2) and at its center.

6. A vibrating sensor according to claim 1,
wherein
the bolt (6*) is coupled to a plunger-type capacitor (C) in order to tap a vibration in the bolt (6*) as a measuring signal.

7. A vibrating sensor according to claim 1,
wherein
the coil (8) is secured to one wall of a housing (1).

8. A vibrating sensor according to claim 1,
wherein
the coil (8) is seated on a coil support (9), such that the coil support (9) secures the coil relative to one wall of the housing (1).

9. A vibrating sensor according to claim 1,
wherein
the diaphragm (2) is positioned on, and specifically fastened to, one wall of a housing (1).

10. A vibrating sensor according to claim 1,
wherein
a coil conductor is electrically insulated with a temperature-resistant jacket.

11. A vibrating sensor according to claim 10,
wherein
the coil body is made of ceramic material.

12. A vibrating sensor according to claim 1,
wherein
the components, particularly the coil conductor, are temperature-resistant up to at least 350° C. and particularly up to 450° C.
